(19) United States
(12) Patent Application Publication
(10) Pub. No.: US 2017/0057003 A1
(43) Pub. Date: Mar. 2, 2017

(54) PLASMA CUTTING MACHINE COMPRISING A PROTECTION DEVICE, AND METHOD FOR OPERATING SAID PLASMA CUTTING MACHINE

(71) Applicant: MESSER CUTTING SYSTEMS GMBH, Gross-Umstadt (DE)

(72) Inventor: Dieter Giezewski, Erbach (DE)

(21) Appl. No.: 15/118,848

(22) PCT Filed: Feb. 9, 2016
(86) PCT No.: PCT/EP2015/052591

§ 371 Date: Aug. 12, 2016

(30) Foreign Application Priority Data
Feb. 12, 2014 (DE) 10 2014 101 719.6

(51) Int. Cl. B23K 10/00

(52) U.S. Cl. CPC B23K 10/006

(57) ABSTRACT

Known plasma cutting machines comprise a plasma burner that can be moved by means of a movement unit, a distance sensor that can be actuated at a low voltage level and has an electronic control unit for determining the distance between a workpiece to be machined and said plasma burner, an ignition device which can be actuated at a high voltage level and by means of which an ignition process can be triggered, and a protection device which moves with said plasma burner for the purpose of protecting the electronic control unit from interference voltage resulting from said ignition process. According to the invention, in order to provide a plasma cutting machine based thereupon which satisfies high demands on interference immunity and operational safety, it is suggested that the protection device contains an electronic circuit which comprises said electronic control unit for the distance sensor, a protection switch having a plurality of protection levels for the purpose of reducing the interference voltage, and an interface to a machine control system.

### TECHNICAL BACKGROUND

The present invention relates to a plasma cutting machine comprising
(a) a plasma burner which can be moved by means of a movement unit,
(b) a distance sensor which can be actuated at a low voltage level and has an electronic control unit for determining the distance between a workpiece to be worked and the plasma burner,
(c) an ignition device which can be actuated at a high voltage level and by means of which an ignition process can be triggered,
(d) and a protection device which is moved with the plasma burner for protecting the electronic control unit against interference voltage resulting from the ignition process.

Furthermore, the present invention relates to a method for operating a plasma cutting machine.

### PRIOR ART

In thermal material processing, an exact process control is crucial for ensuring a high quality of welding and cutting operations on workpieces. An important parameter is here the work distance between the processing tool and the workpiece. Distance measurement and control devices which are standard in practice are based on inductive or capacitive measured-value acquisition.

In a measurement principle known as “initial value finding”, it is intended to bring the plasma burner briefly into contact with the workpiece surface to obtain a reproducible and reliable reference value for distance regulation. The contact is detected as an electrical current/voltage signal by an electronic sensor which is normally housed together with the distance regulation device of a central machine control in a control cabinet. After the initial value finding the plasma burner is moved away into an initial position remote from the workpiece surface, and the ignition process is started.

For this purpose an ignition device that can be actuated at a high voltage level is provided for triggering a plasma arc between an auxiliary electrode and the workpiece. The ignition voltage may here be up to 20 kV. Interference voltages produced in this process (hereinafter also called “transients”) as well as high-frequency components thereof may be cross-coupled into components of the electronic control unit and may lead to damage or malfunction.

DE 195 18 182 A1 which discloses a plasma cutting machine and an operational method according to the above-mentioned type suggests the following electric protection device for limiting that risk.

The plasma burner is vertically movable by means of a positioning drive towards and away from the workpiece to be worked. The distance sensor used is a measuring capacitor having one electrode formed by the workpiece itself and another electrode configured as an annular electrode which is mechanically firmly connected to the plasma burner and also carries out the movements thereof. The capacitance of the measuring capacitor which varies with the distance of the plasma burner from the workpiece is continuously detected by means of a high-frequency measuring-bridge level of a control unit and used for distance regulation.

An ignition device which can be actuated at a high voltage level and by means of which an ignition arc between an auxiliary electrode and the workpiece can first be triggered is provided for igniting the plasma arc. The electric protection device used for protection against overvoltage comprises a spark gap and a glow-discharge tube. The latter is connected between the electrodes of the measuring capacitor, and the spark gap between the annular electrode of the measuring capacitor and its fixed electrode formed by the workpiece. The spark gap is accommodated in a block-shaped plastic housing which is mounted on the burner shaft and therefore also carries out the movements of the plasma burner.

The breakdown voltage of the spark gap is lower than the limit voltage withstood by the electronic control unit even if this voltage occurs permanently at its useful signal input, but it is significantly higher than the maximum level of an alternating-voltage useful signal passed via the capacitor. Damage to the electronic control unit is thereby to be avoided even if upon ignition of the ignition arc a flashover between the auxiliary electrode of the ignition device and the annular electrode of the measuring capacitor should take place.

### TECHNICAL OBJECTIVE

In the known plasma cutting machine the protection device is positioned in the form of the spark gap in direct vicinity of the plasma burner. The electronic control unit used for distance regulation is housed at a safe distance from an actual plasma cutting process, for instance in a control cabinet which is installed next to the machine and which accommodates the central machine control. The control for igniting the arc also takes place from there.

The useful signal line coming from the measurement electrode is configured as a shielded coaxial cable. The high-voltage conducting line and the useful signal line may however converge along the laying path from the actual measuring location up to the control unit, for instance in a so-called cable assembly in which multiple lines are combined within a confined space and which may have a length of several meters. Despite shielding this may lead to flashovers and the coupling of interference voltages into the useful signal line. Bus systems are particularly sensitive in this respect, but these are more and more used in plasma cutting machines for fast data transmission.

Moreover, the electric components for overvoltage limitation, i.e. glow-discharge tubes and spark gap, which are used in the known device, respond relatively slowly, so that especially cross-coupling of high-frequency voltage components from the high-voltage line into the useful-signal line cannot be excluded.

It is therefore the object of the present invention to provide a plasma cutting machine that satisfies high demands on interference immunity and operational safety.

Furthermore, it is the object of the present invention to indicate an operational method suited for the plasma cutting machine, which reliably prevents the cross-coupling of interference signals into the central control unit.

### GENERAL DESCRIPTION OF THE INVENTION

As for the plasma cutting machine, this object starting from a machine of the above-mentioned type is achieved according to the invention in that the protection device contains an electronic circuit which comprises the electronic control unit for the distance sensor, a protection switch having a plurality of protection levels for reducing the interference voltage, and an interface to a machine control.

In the plasma cutting machine according to the invention the protection device is configured as an electronic circuit which, apart from plural protection levels for reducing interference voltage, also comprises the electronic control unit for the distance sensor. Electronic control unit and protection device are accommodated in a joint housing in the simplest case.

Like in the known apparatus, the protection device is arranged upstream of the machine control proper and is disposed in direct vicinity of the plasma burner such that it is moved together with said burner, i.e., it follows the movements of the plasma burner.

The protection device includes a plurality of protection levels for reducing high-voltage flashovers and for eliminating high-frequency voltage signals that develop interference potential due to their frequency. For electrical connection with the machine control the protection device is provided with an interface via which possible useful signals are passed on to the machine control.

The protection device, however, contains not only the said protection switch for reducing high-frequency voltage peaks resulting from the ignition operation, but—in contrast to the prior art—also the electronic control unit for the distance sensor. This makes it possible to complete the initial value finding, the current distance measurement and also evaluation and distance regulation (hereinafter also collectively called “sensor electronics”) entirely within the protection device, i.e. on the plasma burner or in the vicinity thereof. This decentral arrangement of the sensor electronics near the burner offers several advantages:
(1) The signal path of measurement data between the measurement point and the sensor electronics is short. This promotes faster data transmission and higher measuring accuracy.
(2) The transmission of data of the distance measurement and regulation to the central machine control can be omitted so that interference by the coupling of overvoltage into the machine control is ruled out in this respect.
(3) The length of the possibly high voltage-conducting measurement line can be reduced to a minimum, which reduces the interference potential and improves operational safety and process quality.
(4) Moreover, costs and installation times can be reduced.

The individual levels of the protection switch on the one hand and the sensor electronics on the other hand are here preferably configured as electronically separated circuits which only in case of need and in the switched-off state of the high-voltage source are connected to one another.

Due to the thermal and electrical radiation of the plasma the sensor electronics in the direct vicinity of the plasma burner is exposed to high temperatures and high electronic interference emissions. To handle environmental influences, the protection switch is of a multi-level type, each protection level having a specific function with respect to the elimination of voltage interferences (transients) and the preparation of clean signals. Preferred developments of these specific functions will be explained in more detail hereinafter.

The first protection level has an electrical connection to the workpiece and is preferably designed as a high-voltage level for the reduction of interference voltage with more than 100 V, and it comprises at least one diode and a high-frequency filter.

Said high-voltage level is closest to the plasma zone. It primarily serves to reduce high overvoltages and high-frequency interference potentials. For this purpose it has one or more diodes and one or more filters for high frequencies (low-pass filter), wherein at the output side of the protection level the interference potential can be reduced to less than 50 V, preferably less than 36 V. The diode serves to eliminate or reduce the transient, and the low-pass filter to eliminate high-frequency interferences.

The first protection level is configured to be particularly robust with respect to possible transients and is preferably equipped with a switch which allows a connection to the sensor electronics. This switch is only closed if data for distance measurement and regulation are transported. The switch may be of such a sturdy construction, for instance in the form of a relay or a flip switch, that in the opened state a transmission of interferences can fundamentally be ruled out. A reliable prevention of the interferences, however, requires a considerable size of the switch, which is often undesired in the direct vicinity of the plasma burner. As an alternative, and in favor of a constructional shape of the protection device that is as compact as possible, a certain cross-coupling of interference pulses can be accepted if these, as intended in the protection device according to the invention, can be reliably eliminated at subsequent protection levels. Two separate frequency filters that form an impedance are positioned behind the switch.

Depending on the type and extent of an interference potential, the first protection level may turn out to be too slow. Therefore, an impedance in the form of a current-compensated coil is advantageously provided between the first protection level and the second protection level.

A transient remaining after passage through the first protection level has a potential of less than 50 V (preferably less than 36 V) as a rule. It is further reduced by means of the current-compensated coil, so that a non-destructive operation of the electronic components of the second protection level is ensured at an operational voltage of e.g. 12 V, which is provided by the machine control. The second protection level preferably comprises a standard potential separation with at least one DC/DC converter and optocoupler.

DC/DC converter and optocoupler of the second protection level cause a potential separation between the machine potential and the electronic control unit of the distance regulation.

It has turned out to be useful to provide a supply line for the electrical supply of components of the protection levels between the second protection level and a third protection level, with a low-pass filter, which is preferably configured as an LC member, and a protection diode being inserted into the supply line.

The low-pass filter serves to further reduce the frequency interference, and the protection diode to further reduce the transients.

It has been found that frequency interferences and transients may also penetrate from the ground potential side into the electronics. The interference voltages are here propagating via the lines connected to earth (ground) and not via the standard signal and supply lines. These problems arise particularly when, as is common, the workpiece to the worked is earthed, i.e. connected to ground.

To reduce also the transients penetrating from the ground side, the protection circuit therefore advantageously comprises one or plural protection levels against overvoltage and interference frequencies stemming from a ground pole of the electrical voltage supply.

For this purpose, in a preferred embodiment of the plasma cutting machine according to the invention, a low-pass filter, which is preferably configured as an LC member, and a protection diode are inserted into a ground line which is electrically connected to the ground pole and which is provided between the second protection level and a third protection level.

The signal transmission via the ground line between the second and the third protection level is handled with respect to possible electrical interference pulses in the same way as the signal transmission via the supply line between second and third protection level. This particularly means that the low-pass filter causes a smoothing and reduction of high-frequency interference pulses, and the protection diode a reduction of the transients.

The protective effect of said components evolves when the interference pulses can really pass via a correspondingly prepared and protected ground line and cannot escape via other lines. To ensure this, the device of a so-called “floating ground” has turned out to be useful. The reference point of the ground potential is here no longer at zero, so that independently of the potential of the workpiece (the “machine potential”) a multitude of different ground potentials can adjust freely, depending on the interference potential and the electrical state. Such a “floating ground” is per se undesired in the sense of a defined signal processing. In the protection device according to the invention, however, an essential function evolves in that the interference potentials coming from the ground side are reduced.

In this respect the second and third protection level represent a ground-potential protection wiring.

A further essential function of the third protection level consists in converting possible transients into a defined voltage state. For this purpose impedances are particularly provided that comprise fast diodes and capacitors.

It has turned out to be useful to provide a fourth protection level which is equipped with plural impedances and which is connected to the interface to the machine control.

The impedances of the fourth protection level also have the function to convert possible transients into a defined voltage state, so that the transients passing through the fourth protection level can be transmitted without any risk for electronic components of the machine control and without a significant disturbance of signals via the corresponding interface to the machine control.

Advantageously, the interface to the machine control is also connected to the electronic control unit for the distance measurement.

Through this connection an undisturbed low-voltage signal is supplied by the machine control to the electronic control unit and the implementation of the initial value finding is activated via this interface.

As for the operational method of the plasma cutting machine according to the invention, the technical object indicated further above is achieved according to the invention in that the electronic control unit of the distance sensor actuates the movement unit for the plasma burner such that said burner is mounted on the workpiece to be worked, the mounting is recorded as an electrical signal by the control unit, and a reference point for the distance measurement is generated, whereupon the movement unit is actuated such that the plasma burner is moved into a work position above the workpiece, and an ignition process is then triggered by means of the ignition device at a high voltage level, wherein an interference voltage resulting from the ignition process is reduced by means of the protection device moved with the plasma burner, wherein the protection device used is an electronic circuit which comprises the electronic control unit for the distance sensor and a protection switch comprising plural protection levels for reducing the interference voltage, and an interface to a machine control.

The method according to the invention comprises a distance regulation between material and plasma burner in which the initial value finding is carried out by contact between plasma burner and workpiece. This yields a reliable reference value for distance measurement.

A control unit (here also called “sensor electronics”) which is disposed in the direct vicinity of the plasma burner and is moved along with said burner is provided for distance measurement and regulation. It is e.g. mounted directly on the burner shaft or on a transverse carriage by means of which the plasma burner is horizontally moved. By comparison with a control unit accommodated in a stationary control cabinet, a faster measured-value acquisition and data transmission and thus a short dead time in the control follows in the operational method according to the invention due to the close proximity to the measurement point.

The sensor electronics is part of a protection device against overvoltage and other electronic interferences caused by the ignition process. This makes it possible to complete the initial value finding, the ongoing distance measurement as well as evaluation and distance regulation completely within the protection device, i.e. plasma burner or in the vicinity thereof. This decentral arrangement of the sensor electronics yields the advantages explained further above on the basis of the plasma cutting machine according to the invention.

### EMBODIMENT

The invention will now be explained in more detail with reference to embodiments and a drawing. In detail,

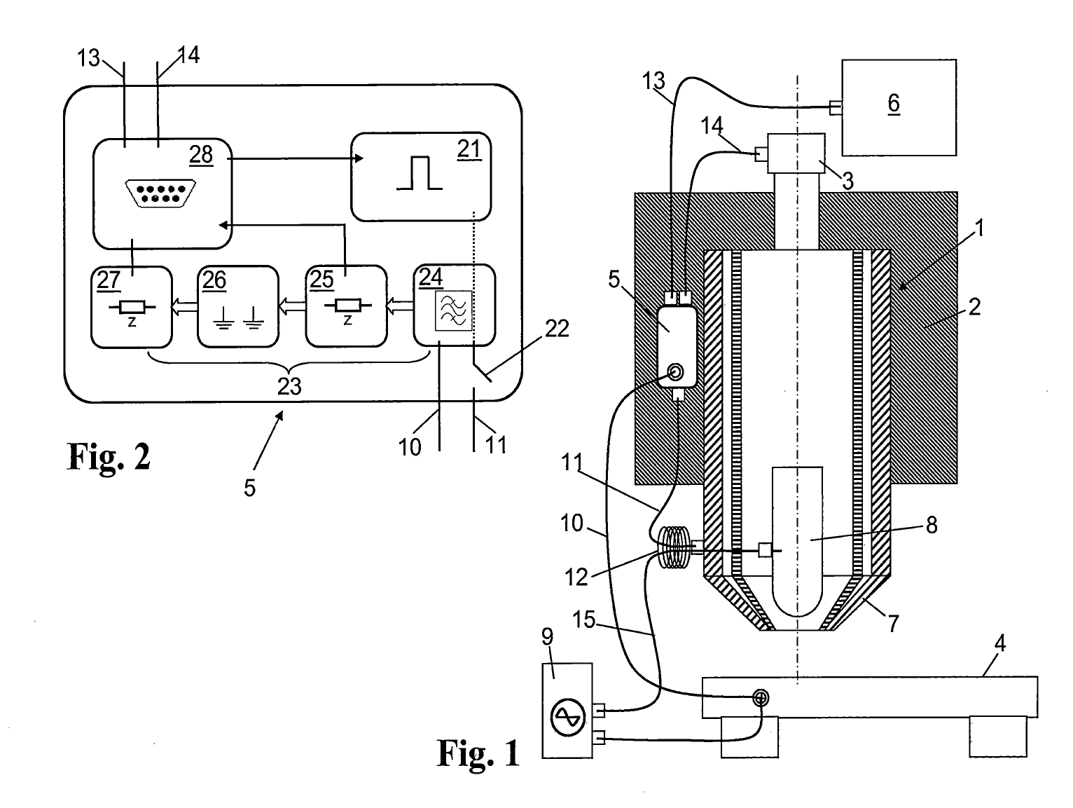

FIG. 1 shows an embodiment of the plasma cutting machine according to the invention, in a schematic illustration with a plasma burner and a protection device with distance regulation, and

FIG. 2 is a schematically simplified block diagram with the protection levels of the protection device and the distance regulation.

FIG. 1 schematically shows a plasma burner 1 of a plasma cutting machine. The burner 1 is movable by means of a schematically illustrated transverse carriage 2 in the standard way in a horizontal plane and in vertical direction by means of a height adjustment device 3. The detection of the distance between the plasma burner 1 and the workpiece 4 to be worked and the control of the height adjustment device 3 take place via sensor electronics which is accommodated together with a protection circuit in a protection device 5. This device is mounted on the transverse carriage 2 in direct vicinity of the plasma burner 1 and is moved along with said burner. The protection device 5, which will be explained in more detail further below with reference to FIG. 2, is connected via a measurement and control line 14 to the height adjustment device 3.

A central machine control 6 which is fixedly installed in a control cabinet on the wall next to the plasma cutting machine is provided for adjusting, monitoring and controlling all of the other machine functions.

The plasma burner 1 comprises a cutting nozzle 7 which defines an exit opening for an ionization gas and which surrounds an inner electrode 8. The cutting nozzle 7 simultaneously serves as an electrode of the capacitive distance measurement. The counter electrode is formed by the workpiece 4 which is of the same potential as the electrical ground.

The free edge of the cutting-nozzle exit opening further serves as an auxiliary electrode for the ignition of an auxiliary arc. For this purpose the cutting nozzle 7 is connected via a shielded high-voltage line 15 to a high-voltage source 9 for 20 kV alternating voltage.

An electric auxiliary arc is thereby producible between the cutting nozzle 7 and the workpiece 4, with the arc in an introductory phase of the cutting operation promoting the formation of the plasma cutting beam proper. The plasma cutting beam burns in the stationary operative state between the inner electrode 8 and the workpiece 4. For this purpose the inner electrode 8 is also connected to the high-voltage source 9 which provides an operating voltage of 300 V with 30 kHz during the cutting operation.

The circuit of the protection device 5 is on the one hand of the same potential as the electrical ground (via the electrical line 10 to the workpiece 4) and is on the other hand connected via a separable useful-signal line 11 to the plasma burner 1. The useful signal line 11 can here extend over a certain distance with the high-voltage line 8 in a common cable assembly 12, which is only schematically illustrated in FIG. 1. Moreover, the protection device 5 is connected via a further useful-signal line 13 for the transmission of 24-V DC voltage to the central machine control 6.

Hence, the protection device 5 is connected between the useful signal line 11 coming from the plasma burner 1 and the useful signal line 13 leading to the machine control 6. This device serves not only to measure and adjust the work distance, but for the machine control 6 and the electronics of the distance sensor it is also operative as a protection switch in case of overvoltages and high-frequency interference voltages from the lines 10 and 11, as will be explained hereinafter in more detail with reference to FIG. 2 and in combination with an example of the method according to the invention.

In a first phase the cutting nozzle 7 is placed on the surface of the workpiece 4 for the initial value finding of the distance regulation. For this purpose the height adjustment device 3 is actuated by the sensor electronics 21 of the protection device 5 in a corresponding way. The switch 22 is here closed, so that the contact between cutting nozzle 7 and workpiece 4 can be detected as an electrical signal by the sensor electronics 21. Owing to the contact signal the plasma burner 1 is moved by means of the height adjustment device 3 into a predetermined work position above the workpiece 4.

In this position an ignition process is initiated in a second phase by means of the machine control 6. An ignition voltage of 20 kV is here applied by means of the high-voltage generator 9 between the inner electrode 8 and the workpiece 4, resulting in a discharge in the form of an ignition arc.

Due to the ignition arc, the plasma gas flowing out of the nozzle exit opening is activated to such an extent that a stable plasma cutting beam is formed between the inner electrode 8 and the workpiece 4 in the third phase at an operational voltage of 300 V and a frequency of 30 kHz. Thereupon, the cutting process is started, with the distance between burner 1 and workpiece 4 being measured and regulated by means of the sensor electronics 21, which is fed with a low voltage of 24 V.

The high voltage in the ignition process can cross-couple into the lines 10 and 11, respectively, and must be reduced within a short period of time and over a short route in the protection device 5 to avoid damage to electronic components and also process malfunctions. For this purpose the protection device 5 has a protection circuit 23 with a total of four protection levels 24, 25, 26 and 27.

At the first protection level 24, diodes and high-frequency filters are substantially connected in parallel. These are functional elements for the reduction of high voltage of more than 100 V and high-frequency interference potentials. At the output side of the first protection level 24 the interference potential is not more than 36 V.

An impedance which comprises current-compensated coil and two capacitors, each with a capacitance of 47 nF, and which serves to further reduce the energy of non-eliminated transients of the first protection level is provided between the first protection level 24 and the second protection level 25.

The second protection level 25 forms a potential separation between the machine potential and the sensor electronics. A DC/DC converter and an optocoupler are the essential functional elements. Moreover, the optocoupler is connected to the sensor electronics 21. Upon contact of the plasma burner with the workpiece the optocoupler detects a current flow and gives this information to the machine control (for triggering the above-explained ignition process).

A supply line coming from the machine control is provided between the second protection level 25 and the third protection level 26. An LC member is inserted as a low-pass filter into said supply line. The LC member is additionally provided with a protection diode, whereby the voltage is limited to 24V/DC and an undisturbed power supply of the electronic components of the protection device is ensured.

Since transients may also enter via the ground line 10 into the electronics, the same protection assembly, i.e. an LC member as the low-pass filter with a protection diode for voltage limitation, is also inserted into the ground line 10 between the second protection level 25 and the third protection level 26.

The protective effect of the electronic components which is thereby aimed at is ensured in that the power supply is configured at the second protection level 25 with a floating ground potential. In a “floating ground” the ground potential is separated from the fixed reference potential (zero), so that it can freely adjust, depending on the interference potential and the electrical state. Owing to this “floating ground”, interference potentials coming from the ground side can be mitigated and possible transients can be converted into a defined voltage state.

The third protection level 26 thereby represents a ground-potential protection wiring and it serves on the other hand to convert possible transients into a defined voltage state to achieve a “clean” 24V/DC useful signal and thus a reliable function of the electronic components of the protection device. Impedances are particularly provided for this purpose, said impedances including fast diodes and capacitors. In other words, by ensuring a clean supply voltage one can ensure a defined and reproducible state of the useful signals and an operationally safe function of the protection device.

At the fourth protection level 27 the incoming signals are prepared for transmission to the machine control 6. An undisturbed 24 V control voltage is provided. This protection level has impedances contributing to the provision of the above-explained floating ground. The fourth protection level 27 is connected to an interface 28 to the machine control 6 (line 13), which is also part of the sensor electronics 21 and through which the height adjustment device 3 is addressed (line 14).

1. A plasma cutting machine comprising:
a plasma burner that is configured to be moved by a movement unit,
a distance sensor that is configured to be actuated at a low voltage level and has an electronic control unit determining the distance between a workpiece to be worked and the plasma burner,
an ignition device that triggers an ignition process when actuated at a high voltage level,
and a protection device that is moved with the plasma burner, said protection device protecting the electronic control unit against interference voltage resulting from the ignition process,
wherein the protection device contains an electronic circuit that includes comprises the electronic control unit of the distance sensor, a protection switch having a plurality of protection levels reducing the interference voltage, and an interface to a machine control.

2. A plasma cutting machine according to claim 1, wherein a first protection level has an electrical connection to the workpiece and is configured as a high-voltage protection level reducing interference voltage with more than 100 V, the electrical connection comprising a diode and a high-frequency filter.

3. A plasma cutting machine according to claim 1, wherein an impedance in the form of a current-compensated coil is provided between the first protection level and a second protection level.

4. A plasma cutting machine according to claim 3, wherein the second protection level has a potential separation with at least one DC/DC converter and an optocoupler.

5. A plasma cutting machine according to claim 3, wherein a supply line electrically supplying components of the protection levels is provided between the second protection level and a third protection level, and the supply line has inserted therein a low-pass filter, and a protection diode.

6. A plasma cutting machine according to claim 1, wherein the protection circuit comprises one or plural protection levels against overvoltage and interference frequencies starting from a ground pole of an electrical voltage supply.

7. A plasma cutting machine according to claim 6, wherein a ground line electrically connected to the ground pole is provided between the second protection level and a third protection level, and the ground line has inserted therein a low-pass filter and a protection diode.

8. A plasma cutting machine according to claim 7, wherein a first ground potential is generated at the second protection level and a second ground potential at the third protection level, which jointly form a floating ground.

9. A plasma cutting machine according to claim 8, wherein the third protection level is a ground-potential protection wiring that comprises plural impedances in the form of frequency-dependent coils and fast diodes and capacitors.

10. A plasma cutting machine according to claim 1, wherein a fourth protection level that is equipped with plural impedances is provided and connected to the interface to the machine control.

11. A plasma cutting machine according to claim 1, wherein the interface is connected to the electronic control unit providing distance measurement.

12. A method for operating the plasma cutting machine according to claim 1, said method comprising:
actuating with the electronic control unit of the distance sensor the movement unit for the plasma burner such that said burner is mounted on the workpiece to be worked,
recording the mounting as an electrical signal by the control unit and
generating a reference point for the distance measurement,
wherein the actuating of the movement unit is such that the plasma burner is moved into a work position above the workpiece, and
triggering an ignition process using the ignition device at a high voltage level,
wherein an interference voltage resulting from the ignition process is reduced using the protection device moved with the plasma burner,
wherein the electronic circuit is used as the protection device, said electronic circuit comprising the electronic control unit for the distance sensor and a protection circuit comprising a plurality of protection levels reducing the interference voltage, and the interface to the machine control.

13. A plasma cutting machine according to claim 5, wherein the low-pass filter is configured as an LC member.

14. A plasma cutting machine according to claim 7, wherein the low-pass filter is configured as an LC member.
